(19) United States
(12) Patent Application Publication
(10) Pub. No.: US 2010/0001063 A1
(43) Pub. Date: Jan. 7, 2010

(54) TRANSACTION OVERRIDE USING RADIO FREQUENCY IDENTIFICATION

(75) Inventors: James Patrick Bowles, Raleigh, NC (US); Tracy Michael Canada, Fuquay-Varina, NC (US)

Correspondence Address: DUKE W. YEE;YEE & ASSOCIATES, P.C., P.O. BOX 802333, DALLAS, TX, 75380, US

(73) Assignee: INTERNATIONAL BUSINESS MACHINES CORPORATION, Armonk, NY (US)

(21) Appl. No.: 12/165,845

(22) Filed: Jul. 1, 2008

(51) Int. Cl. G06K 7/00

(52) U.S. Cl. 235/380

(57) ABSTRACT

A system for overriding retail transactions. In response to receiving an input to override a retail transaction, it is determined whether data on an RFID card has been read. The data is read by an RFID reader located on a POS device keyboard. In response to determining that the data has been read, a light emitting diode is used to indicate that the data has been read. Then, the data is sent to a central computer to validate that a user of the RFID card is authorized to perform the override. In response to receiving a validation result from the central computer, it is determined whether the user of the RFID card is authorized to perform the override. Then, in response to determining that the user of the RFID card is authorized to perform the override, the user of the RFID card is permitted to complete the retail transaction override.

### BACKGROUND OF THE INVENTION

1. Field of the Invention

The present invention relates generally to an improved data processing system and more specifically to a computer implemented method, system, and computer usable program code for overriding a retail transaction at a point of sale device using radio frequency identification (RFID).

2. Description of the Related Art

A point of sale (POS) device is a checkout device where transactions occur. More specifically, the POS device often refers to the hardware and software used for checkouts, which is the equivalent of an electronic cash register. Point of sale systems are used in a multitude of locations, such as supermarkets, restaurants, hotels, stadiums, and casinos, as well as almost any type of retail environment. Currently, the override process for retail transactions is done via a manual key insertion by an authorized manager into a POS device keyboard.

### BRIEF SUMMARY OF THE INVENTION

According to one embodiment of the present invention, a retail transaction is overridden using RFID. In response to receiving an input to override a retail transaction, it is determined whether data on an RFID card has been read. The data on the RFID card is read by an RFID reader located on a keyboard of a POS device that received the input. In response to determining that the data on the RFID card has been read, a light emitting diode on the keyboard is used to indicate that the data on the radio frequency identification card has been read. Then, the data is sent via a network to a central data processing system to validate that a user of the RFID card is authorized to perform the override of the retail transaction. In response to receiving a validation result from the central data processing system, it is determined whether the user of the RFID card is authorized to perform the override of the retail transaction. Then, in response to determining that the user of the RFID card is authorized to perform the override of the retail transaction, the user of the RFID card is permitted to complete the override of the retail transaction.

### BRIEF DESCRIPTION OF THE SEVERAL VIEWS OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIG. 3 is a pictorial representation of a retail POS device keyboard in accordance with an illustrative embodiment;

FIG. 4 is a pictorial representation of an RFID card in accordance with an illustrative embodiment; and

FIG. 5 is a flowchart illustrating an exemplary process for overriding a retail transaction using RFID in accordance with an illustrative embodiment.

### DETAILED DESCRIPTION OF THE INVENTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, the present invention may take the form of a computer program product embodied in any tangible medium of expression having computer usable program code embodied in the medium.

Any combination of one or more computer-usable or computer-readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

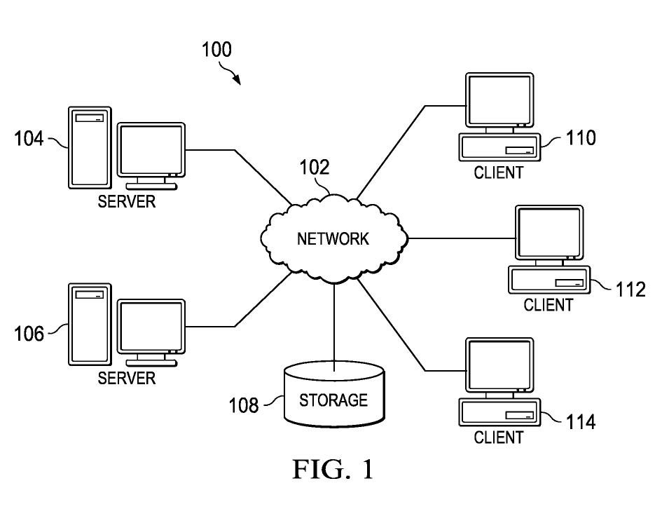

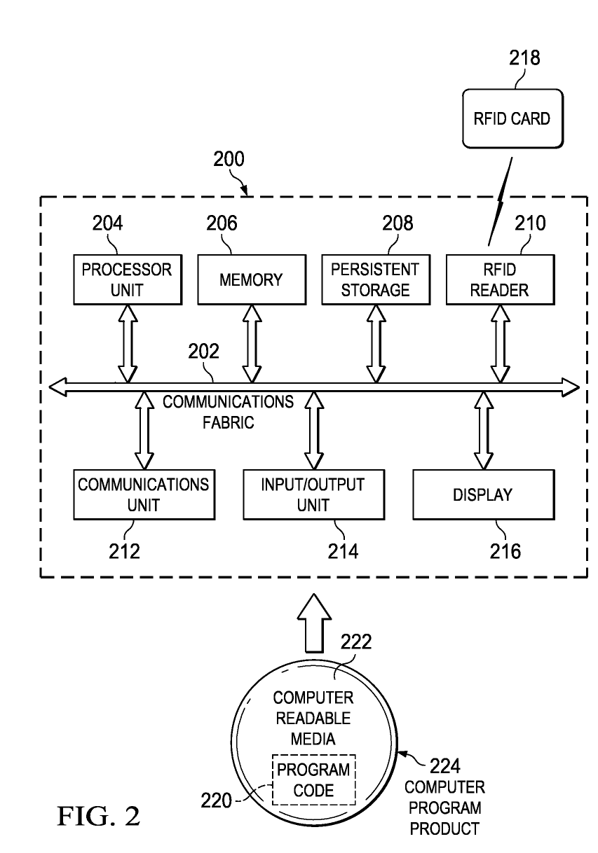

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to data processing environments in which different illustrative embodiments may be implemented. Many modifications to the depicted environments may be made.

FIG. 1 depicts a pictorial representation of a network of data processing systems in which illustrative embodiments may be implemented. Network data processing system 100 is a network of data processing systems, such as, for example, computers and other devices, in which the illustrative embodiments may be implemented. Network data processing system 100 contains network 102. Network 102 is the medium used to provide communications links between the various computers and other devices connected together within network data processing system 100. Network 102 may include connections, such as wire, wireless communication links, or fiber optic cables.

In the depicted example, server 104 and server 106 connect to network 102, along with storage unit 108. Storage 108 represents any type of storage device that is capable of storing data in a structured or unstructured format. Also, storage 108 may represent a plurality of storage units coupled to network 102. Storage 108 may, for example, be a database that stores retail transaction data and transaction override authorization data.

Further, client devices 110, 112, and 114 also connect to network 102. Client devices 110, 112, and 114 may, for example, be POS devices, personal computers, and/or network computers. A POS device refers to the hardware and software components that are used to perform retail transactions.

Client devices 110, 112, and 114 are clients to server 104 and/or server 106 in this example. Server 104 and server 106 provide transaction override authorization data to client devices 110, 112, and 114. Furthermore, server 104 and server 106 may provide other data, such as boot files, operating system images, and applications to client devices 110, 112, and 114. Moreover, network data processing system 100 may include additional servers, clients, and other devices not shown.

Of course, network data processing system 100 may be implemented as a number of different types of networks, such as, for example, an intranet, a local area network (LAN), a wide area network (WAN), or the Internet. Also, is should be noted that FIG. 1 is only intended as an example and not as an architectural limitation for the different illustrative embodiments.

With reference now to FIG. 2, a block diagram of a data processing system is shown in which illustrative embodiments may be implemented. Data processing system 200 is an example of a POS device, such as client 110 in FIG. 1, in which computer-usable program code or instructions implementing the processes of the illustrative embodiments may be located. In this illustrative example, data processing system 200 includes communications fabric 202, which provides communications between processor unit 204, memory 206, persistent storage 208, RFID reader 210, communications unit 212, input/output (I/O) unit 214, and display unit 216.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory (RAM) or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208. In addition, persistent storage 208 may represent a plurality of persistent storage units.

RFID reader 210 is a component capable of reading data contained on RFID card 218 when RFID card 218 is in close proximity with RFID reader 210. RFID is a generic term for technologies that use radio waves to automatically identify people or objects. There are several methods of identification, but the most common is to store a serial number that identifies the person or object on a microchip that is attached to an antenna. The microchip and the antenna together are called an RFID transponder or an RFID tag. The antenna enables the chip to transmit the identification data to RFID reader 210. The RFID transponder or tag is embedded in, or otherwise attached to, RFID card 218. RFID reader 210 converts the radio waves reflected back from the RF ID tag into digital data that may then be conveyed to a central computer, such as server 104 in FIG. 1, which analyzes the data.

Communications unit 212, in these examples, provides for communications with other data processing systems or devices, such as, for example, server 104 in FIG. 1. In these examples, communications unit 212 is a network interface card. Communications unit 212 may provide communications through the use of either, or both, physical and wireless communications links.

Input/output unit 214 allows for input and output of data with other devices that may be connected to data processing system 200. For example, input/output unit 214 may provide a connection for user input through a keyboard. Display unit 216 provides a mechanism to display information to a user of data processing system 200.

Instructions for the operating system and applications or programs are located on persistent storage 208. The instructions for the operating system and applications or programs may be loaded into memory 206 for execution by processor unit 204. The processes of the different embodiments may be performed by processor unit 204 using computer implemented instructions, which may be located in a memory, such as memory 206. These instructions are referred to as program code, computer-usable program code, or computer-readable program code that may be read and executed by a processor in processor unit 204. The program code in the different illustrative embodiments may be embodied on different physical or tangible computer-readable media, such as memory 206 or persistent storage 208.

Program code 220 is located in a functional form on computer-readable media 222 and may be loaded onto or transferred to data processing system 200 for execution by processor unit 204. Program code 220 and computer-readable media 222 form computer program product 224 in these examples. In one example, computer-readable media 222 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 222 also may take the form of a persistent storage, such as a hard drive or a flash memory that is connected to data processing system 200. The tangible form of computer-readable media 222 is also referred to as computer-recordable storage media.

Alternatively, program code 220 may be transferred to data processing system 200 from computer-readable media 222 through a communications link to communications unit 212 and/or through a connection to input/output unit 214. The communications link and/or the connection may be physical or wireless in the illustrative examples. The computer-readable media also may take the form of non-tangible media, such as communications links or wireless transmissions containing the program code.

The different components illustrated for data processing system 200 are not meant to provide architectural limitations to the manner in which different illustrative embodiments may be implemented. The different illustrative embodiments may be implemented in a data processing system including components in addition to, or in place of, those illustrated for data processing system 200. Other components shown in FIG. 2 may be varied from the illustrative examples shown.

For example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache, such as found in an interface and memory controller hub, which may be present in communications fabric 202.

Illustrative embodiments provide a computer implemented method, system, and computer usable program code for overriding a retail transaction at a POS device using RFID. In response to receiving an input to override a retail transaction by an authorized user, the POS device determines whether identification data on an RFID card associated with the authorized user has been read. The POS device uses an RFID reader located on a keyboard of the POS device to read the data on the RFID card. In response to determining that the data on the RFID card has been read, the POS device uses a light emitting diode on the keyboard to indicate to the authorized user that the data on the radio frequency identification card has been read. For example, the light emitting diode may turn green after a successful RFID read.

Then, the POS device sends the identification data via a network to a central data processing system to validate that the user of the RFID card is authorized to perform the override of the retail transaction. In response to receiving a validation result from the central data processing system, the POS device determines whether the user of the RFID card is authorized to perform the override of the retail transaction. Then, in response to determining that the user of the RFID card is authorized to perform the override of the retail transaction, the POS device permits the authorized user to complete the retail transaction override.

The authorized user may, for example, be a retail store manager. The manager is assigned a card or a badge that includes RFID functionality, such as an RFID transponder. An industry standard RFID card may act as the transponder. Illustrative embodiments utilize a retail POS device that includes a keyboard equipped with an RFID reader, instead of the current key port, used for transaction overrides. The RFID reader may, for example, be placed on the keyboard in a quadrant where the key port was located. Using RFID technology, illustrative embodiments eliminate problems, such as lost keys, broken keys, or malfunctioning key ports. The RFID for each manager with authorized override access may be activated locally at each retail store.

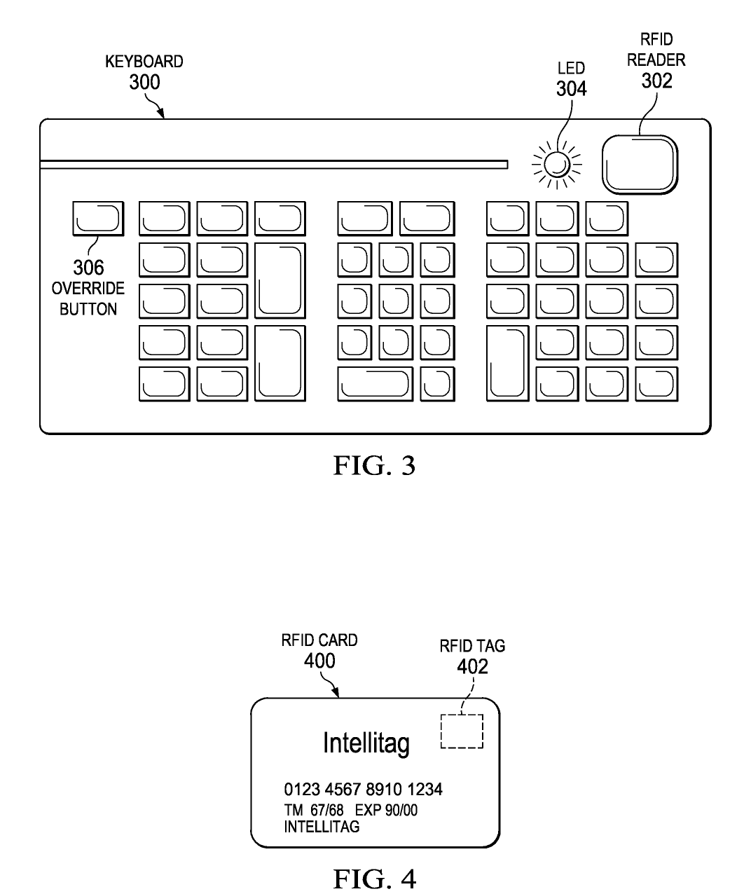

With reference now to FIG. 3, a pictorial representation of a retail POS device keyboard is depicted in accordance with an illustrative embodiment. Keyboard 300 may, for example, be input/output unit 214 in FIG. 2. Keyboard 300 is coupled to a POS device, such as client 110 in FIG. 1. Keyboard 300 includes RFID reader 302, light emitting diode (LED) 304, and override button 306.

RFID reader 302 may, for example, be RFID reader 210 in FIG. 2. The POS device uses RFID reader 302 to read data contained on an RFID card, such as RFID card 218 in FIG. 2, when the RFID card is in close proximity to RFID reader 302. An authorized manager may use the RFID card to, for example, override a retail transaction inputted into the POS device by a store clerk or cashier. It should be noted that even though RFID reader 302 in this illustrative example is located in the upper right quadrant of keyboard 300, RFID reader 302 may be located anywhere on keyboard 300 to accommodate processes of illustrative embodiments. The same holds true for the locations of LED 304 and override button 306 on keyboard 300.

The POS device uses LED 304 to indicate to a user, such as an authorized manager, that a successful read of the RFID card occurred. For example, LED 304 may light green after RFID reader 302 reads the RFID card. Alternatively, LED 304 may change colors from, for example, red to green, after RFID reader 302 successfully reads the RFID card. An authorized manager uses override button 306 to initiate the override process for a retail transaction.

With reference now to FIG. 4, a pictorial representation of an RFID card is depicted in accordance with an illustrative embodiment. RFID card 400 may, for example, be RFID card 218 in FIG. 2. RFID card 400 includes RFID tag 402. RFID tag 402 contains identification data that uniquely identifies a user of RFID card 400, such as an authorized manager.

RFID tag 402 may, for example, be a passive RFID tag, which has no internal power supply. Minute electrical current is induced in an antenna of RFID tag 402 by incoming radio frequency signals from an RFID reader, such as RFID reader 302 in FIG. 3, that provides just enough power for a microchip in RFID tag 402 to power up and transmit back (backscatter) a response to the RFID reader. Alternatively, RFID tag 402 may be an active RFID tag, which does include an internal power supply. Active RFID tags, due to their onboard power supply, transmit at higher power levels than do passive RFID tags, which allow active RFID tags to be more effective at longer distances or in “radio frequency challenged” environments.

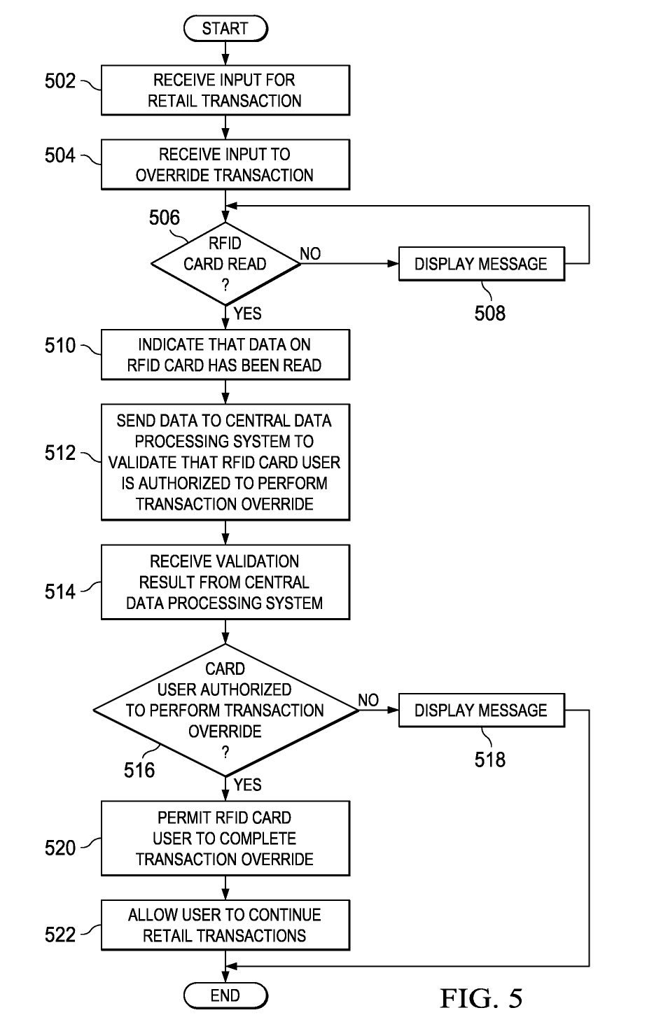

With reference now to FIG. 5, a flowchart illustrating an exemplary process for overriding a retail transaction using RFID is shown in accordance with an illustrative embodiment. The process shown in FIG. 5 may be implemented in a POS device, such as data processing system 200 in FIG. 2.

The process begins when the POS device receives an input for a retail transaction (step 502). The retail transaction input is received from a user, such as a store cashier, utilizing, for example, a keyboard, such as keyboard 300 in FIG. 3, or a barcode scanner. However, for whatever reason, a transaction override must be performed. As a result, the cashier summons an authorized store manager to perform the override procedure. The cashier may summon the authorized manager via, for example, an electronic page on a pager device initiated by one or more predetermined keystrokes on the keyboard or via an intercom system.

Then, the POS device receives an input to override the transaction (step 504). The override input is received from the authorized manager via an override button, such as override button 306 in FIG. 3, located on the keyboard. Afterward, the authorized manager places an RFID card, such as RFID card 400 in FIG. 4, or RFID badge in close proximity to an RFID reader, such as RFID reader 302 in FIG. 3, located on the keyboard. Subsequently, the RFID reader reads the data contained on the RFID card. The data contained on the RFID card uniquely identifies the manager and is used to confirm that the manager is authorized to perform the override procedure.

Then, the POS device makes a determination as to whether the RFID reader read the RFID card (step 506). If the RFID reader did not read the RFID card, no output of step 506, then the POS device may display a message in a display, such as display 216 in FIG. 2, to alert the RFID card user (step 508). The message may, for example, be “Please present RFID card.” Thereafter, the process returns to step 506. If the RFID reader did read the RFID card, yes output of step 506, then the POS device indicates that the data on the RFID card has been read (step 510). The POS device may indicate that the data has been read using, for example, an LED, such as LED 304 in FIG. 3, located on the keyboard.

Afterward, the POS device sends the data to a central data processing system, such as server 104 in FIG. 1, to validate that the RFID card user is authorized to perform the transaction override (step 512). The central data processing system may, for example, compare the received data with transaction override authorization data stored in a database, such as storage 108 in FIG. 1, to validate that the RFID card user is authorized to perform the transaction override. Subsequently, the POS device receives a validation result from the central data processing system (step 514). The validation result notifies the POS device of the validation process result (i.e., whether the RFID card user is authorized to perform the transaction override or not).

Then, the POS device makes a determination as to whether the card user is authorized to perform the transaction override (step 516). If the card user is not authorized to perform the transaction override, no output of step 516, then the POS device displays a message in the display to alert the RFID card user (step 518). The message may, for example, be “Override authorization denied.” Thereafter, the process terminates. If the RFID card user is authorized to perform the transaction override, yes output of step 516, then the POS device permits the RFID card user to complete the transaction override (step 520). After the transaction override is completed by the RFID card user, the POS device allows the user to continue with retail transactions (step 522). The process terminates thereafter.

Thus, illustrative embodiments of the present invention provide a computer implemented method, system, and computer program product for overriding a retail transaction at a point of sale device using RFID. The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A computer implemented method for overriding a retail transaction using radio frequency identification, the computer implemented method comprising:
responsive to receiving an input to override a retail transaction, determining whether data on a radio frequency identification card has been read, wherein the data on the radio frequency identification card is read by a radio frequency identification reader located on a keyboard of a point of sale device that received the input;
responsive to determining that the data on the radio frequency identification card has been read, indicating that the data on the radio frequency identification card has been read using a light emitting diode on the keyboard;
sending the data via a network to a central data processing system to validate that a user of the radio frequency identification card is authorized to perform the override of the retail transaction;
responsive to receiving a validation result from the central data processing system, determining whether the user of the radio frequency identification card is authorized to perform the override of the retail transaction; and
responsive to determining that the user of the radio frequency identification card is authorized to perform the override of the retail transaction, permitting the user of the radio frequency identification card to complete the override of the retail transaction.

2. The computer implemented method of claim 1, further comprising:
allowing a regular user of the point of sale device to continue to input retail transactions after the override of the retail transaction is completed.

3. The computer implemented method of claim 1, wherein the user of the radio frequency identification card is an authorized retail store manager.

4. The computer implemented method of claim 1, wherein the radio frequency identification card includes a radio frequency identification tag, and wherein the radio frequency identification tag contains the data, and wherein the data uniquely identifies the authorized retail store manager.

5. The computer implemented method of claim 1, wherein the radio frequency identification reader is located in an upper right quadrant of the keyboard.

6. The computer implemented method of claim 1, wherein the point of sale device is located in a retail environment, and wherein the point of sale device is coupled to the network.

7. A computer program product stored in a computer usable medium having computer usable program code embodied therein for overriding a retail transaction using radio frequency identification, the computer program product comprising:
computer usable program code configured to determine whether data on a radio frequency identification card has been read in response to receiving an input to override a retail transaction, wherein the data on the radio frequency identification card is read by a radio frequency identification reader located on a keyboard of a point of sale device that received the input;
computer usable program code configured to indicate that the data on the radio frequency identification card has been read using a light emitting diode on the keyboard in response to determining that the data on the radio frequency identification card has been read;
computer usable program code configured to send the data via a network to a central data processing system to validate that a user of the radio frequency identification card is authorized to perform the override of the retail transaction;
computer usable program code configured to determine whether the user of the radio frequency identification card is authorized to perform the override of the retail transaction in response to receiving a validation result from the central data processing system; and
computer usable program code configured to permit the user of the radio frequency identification card to complete the override of the retail transaction in response to determining that the user of the radio frequency identification card is authorized to perform the override of the retail transaction.
